(19) United States
(12) Patent Application Publication
(10) Pub. No.: US 2023/0317965 A1
(43) Pub. Date: Oct. 5, 2023

(54) ELECTRODE LAMINATE AND SECONDARY BATTERY

(71) Applicant: HONDA MOTOR CO., LTD., Tokyo (JP)

(72) Inventors: Kazuki CHIBA, Saitama (JP); Toshiyuki ARIGA, Saitama (JP)

(21) Appl. No.: 18/177,132

(22) Filed: Mar. 2, 2023

(30) Foreign Application Priority Data
Mar. 31, 2022 (CN) 202210346205.X

(51) Int. Cl. H01M 4/70; H01M 50/54; H01M 4/38; H01M 4/485; H01M 4/48; H01M 4/134; H01M 4/131; H01M 4/136; H01M 4/58; H01M 4/587

(52) U.S. Cl. CPC H01M 4/70; H01M 50/54; H01M 4/382; H01M 4/381; H01M 4/386; H01M 4/485; H01M 4/48; H01M 4/134; H01M 4/131; H01M 4/136; H01M 4/5815; H01M 4/587; H01M 2004/027

(57) ABSTRACT

It is an object to provide an electrode laminate and a secondary battery capable of reducing manufacturing costs and preventing non-uniform electrode reactions during charging and discharging. An electrode laminate (1) includes a plurality of sheet-shaped negative electrodes (2), a plurality of sheet-shaped solid electrolytes (3), and a plurality of sheet-shaped positive electrodes (4). The plurality of negative electrodes (2), the plurality of solid electrolytes (3), and the plurality of positive electrodes (4) are laminated together within a predetermined range. The negative electrode current collecting part (2A) and the positive electrode current collecting part (4A) each have a shape that tapers toward a direction away from the predetermined range.

This application is based on and claims the benefit of priority from Chinese Patent Application No. 202210346205.X, filed on 31 Mar. 2022, the content of which is incorporated herein by reference.

### BACKGROUND OF THE INVENTION

### Field of the Invention

The present invention relates to an electrode laminate and a secondary battery.

### Related Art

In recent years, research and development have been conducted on secondary batteries that contribute to energy efficiency in order to ensure more people have access to reasonable, reliable, sustainable, and advanced energy. Among the secondary batteries, solid-state batteries have attracted particular attention because a solid electrolyte is non-flammable and thus safety is improved, and the solid-state batteries are superior in that they have a higher energy density. As such a secondary battery, a secondary battery including an electrode laminate is known (for example, see Patent Documents 1 and 2).

The electrode laminate included in the secondary battery includes a plurality of sheet-shaped negative electrodes, a plurality of sheet-shaped solid electrolytes, and a plurality of sheet-shaped positive electrodes, and these are laminated together within a predetermined range. In the plurality of negative electrodes, parts protruding from the predetermined range toward one side are bonded together with a sealant, thereby forming a tab on the negative electrode side. In the plurality of positive electrodes, parts protruding from the predetermined range toward the other side are bonded together with a sealant, thereby forming a tab on the positive electrode side.
Patent Document 1: Japanese Unexamined Patent Application, Publication No. 2016-219382
Patent Document 2: Japanese Unexamined Patent Application, Publication No. 2019-046592

### SUMMARY OF THE INVENTION

When tabs 101 and 102 are large as in an electrode laminate 100 of Patent Document 1 shown in FIG. 8, sealants 103 and 104 are correspondingly large, which increases the manufacturing cost. As in an electrode laminate 200 of Patent Document 2 shown in FIG. 9, when tabs 201 and 202 are made smaller and quadrangular, current C concentrates in the center during charging and discharging, resulting in non-uniform electrode reactions.

In response to the above issues, it is an object of the present invention to provide an electrode laminate and a secondary battery capable of reducing manufacturing costs and preventing non-uniform electrode reactions during charging and discharging.

(1) A first aspect of the present invention is an electrode laminate (e.g., the electrode laminate 1 described later), including a plurality of sheet-shaped negative electrodes (e.g., the negative electrodes 2 described later), a plurality of sheet-shaped solid electrolytes or separators (e.g., the solid electrolytes 3 described later), and a plurality of sheet-shaped positive electrodes (e.g., the positive electrodes 4 described later). The plurality of negative electrodes, the plurality of solid electrolytes or separators, and the plurality of positive electrodes are laminated together within a predetermined range. In the plurality of negative electrodes, negative electrode current collecting parts (e.g., the negative electrode current collecting parts 2A described later) protruding from the predetermined range to one side are bonded together. In the plurality of positive electrodes, positive electrode current collecting parts (e.g., the positive electrode current collecting parts 4A described later) protruding from the predetermined range to the other side are bonded together. At least one of the negative electrode current collecting parts or the positive electrode current collecting parts have a shape that tapers toward a direction away from the predetermined range.

The electrode laminate according to the present invention allows at least one of the negative electrode current collecting parts or the positive electrode current collecting parts to be smaller. This allows a sealant to be smaller, resulting in lower manufacturing costs. Further, the electrode laminate according to the present invention allows current to be dispersed during charging and discharging, thus preventing non-uniform electrode reactions.

(2) In a second aspect of the present invention according to the first aspect, the negative electrodes preferably include at least one of lithium, sodium, potassium, silicon, or alloys thereof.

According to the electrode laminate of the present invention, since the negative electrodes include at least one of lithium, sodium, potassium, silicon, or alloys thereof, each of which can undergo dissolution and precipitation reactions, non-uniform electrode reactions can be further prevented during charging and discharging.

(3) In a third aspect of the present invention, a secondary battery according to the present invention preferably includes the electrode laminate.

The secondary battery according to the present invention allows at least one of the negative electrode current collecting parts or the positive electrode current collecting parts to be smaller. This allows a sealant to be smaller, resulting in lower manufacturing costs. Further, the secondary battery according to the present invention allows current to be dispersed during charging and discharging, thus preventing non-uniform electrode reactions.

According to the present invention, it is possible to reduce manufacturing costs and to prevent non-uniform electrode reactions.

### BRIEF DESCRIPTION OF THE DRAWINGS

FIG. 1 is a schematic view showing the configuration of an electrode laminate according to an embodiment of the present invention;

FIG. 2 is a plan view explaining a manufacturing step of the electrode laminate and shows a current collector formation step;

FIG. 3 is a perspective view explaining a manufacturing process of the electrode laminate and shows a lamination step;

FIG. 4 is a plan view explaining a manufacturing step of the electrode laminate and shows lamination misalignment in the lamination step;

FIG. 5 is a plan view explaining a manufacturing step of the electrode laminate and shows a bonding step;

FIG. 6 is a side view explaining a manufacturing step of the electrode laminate and shows the bonding step;

FIG. 7 is a plan view explaining a manufacturing step of the electrode laminate and shows a cutting step;

FIG. 8 is a schematic view showing the configuration of a conventional electrode laminate; and

FIG. 9 is a schematic view showing the configuration of a conventional electrode laminate.

### DETAILED DESCRIPTION OF THE INVENTION

Embodiments of the present invention will now be described in detail with reference to the drawings.

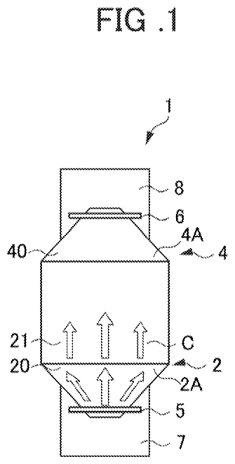

First, with reference to FIG. 1, the configuration of an electrode laminate 1 according to an embodiment of the present invention will be described. FIG. 1 is a schematic view showing the configuration of the electrode laminate 1. The electrode laminate 1 according to the present embodiment is applied to a secondary battery, and the secondary battery is more preferably a solid-state battery. In the following description, the electrode laminate 1 may be described as a solid-state battery including a solid electrolyte. On the other hand, the electrode laminate 1 of the present invention can also be applied to a liquid battery including an electrolytic solution.

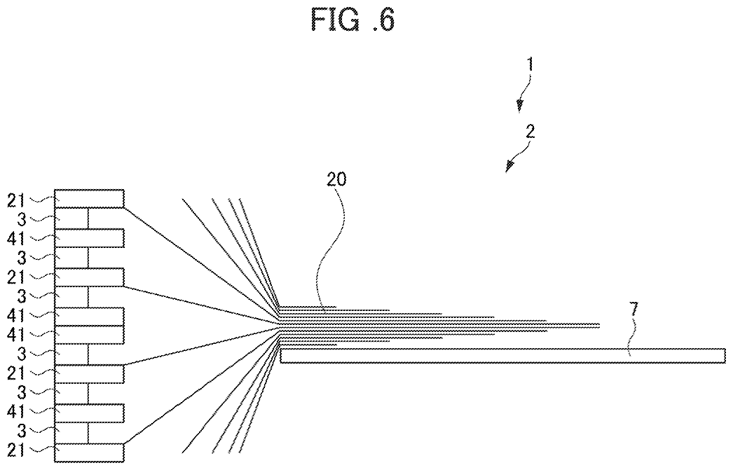

The electrode laminate 1 shown in FIG. 1 includes a plurality of sheet-shaped negative electrodes 2, a plurality of sheet-shaped solid electrolytes 3 (see FIG. 6), a plurality of sheet-shaped positive electrodes 4, sealants 5 and 6, and lead tabs 7 and 8. The plurality of negative electrodes 2, the plurality of solid electrolytes 3 (see FIG. 6), and the plurality of positive electrodes 4 are laminated together within a predetermined range. When the secondary battery to which the electrode laminate 1 is applied is a liquid battery, separators may be used instead of the solid electrolytes 3.

Each of the plurality of negative electrodes 2 includes a negative electrode current collector 20 and a negative electrode layer 21 formed on one surface or both surfaces of the negative electrode current collector 20. The plurality of negative electrodes 2 are laminated with the plurality of solid electrolytes 3 (see FIG. 6) and the plurality of positive electrodes 4 within a predetermined range in which the negative electrode layers 21 are formed on the surfaces of the negative electrode current collectors 20. In the plurality of negative electrodes 2, parts protruding to one side from the predetermined range in which the negative electrode layers 21 are formed on the surfaces of the negative electrode current collectors 20, i.e., parts where the negative electrode current collectors 20 are exposed, are bonded together with the sealant 5 and bonded to the lead tab 7, whereby a negative electrode current collecting part 2A is formed. The negative electrode current collecting part 2A has a shape that tapers toward a direction away from the predetermined range in which the negative electrode layers 21 are formed on the surfaces of the negative electrode current collectors 20.

The negative electrode 2 preferably includes, as a negative electrode active material, at least one of lithium, sodium, potassium, silicon, or alloys thereof, each of which can undergo dissolution and precipitation reactions. The negative electrode 2 may include, as a negative electrode active material, a material capable of occluding and releasing a charge transfer medium (e.g., lithium ions).

The negative electrode current collector 20 is not limited as long as it has a function of collecting electricity of the negative electrode layer 21. Examples of the material of the negative electrode current collector 20 include nickel, copper, and stainless steel.

The negative electrode layer 21 contains at least a negative electrode active material. Examples of the negative electrode active material include lithium, sodium, potassium, silicon, and alloys thereof, each of which can undergo dissolution and precipitation reactions, as described above. The negative electrode active material may be a material capable of occluding and releasing a charge transfer medium (e.g., lithium ions). Specific examples of the material include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, metallic lithium, metallic indium, and lithium alloys. The negative electrode active material may be in the form of a powder or a thin film.

The solid electrolyte 3 (see FIG. 6) is disposed between the negative electrode 2 and the positive electrode 4. The solid electrolyte contains at least a solid electrolyte material. Charge transfer medium conduction (e.g., lithium ion conduction) between the negative electrode active material and a positive electrode active material can be performed through the electrolyte material contained in the solid electrolyte. When the secondary battery to which the electrode laminate 1 is applied is a liquid battery, a separator and an electrolytic solution are disposed between the negative electrode 2 and the positive electrode 4.

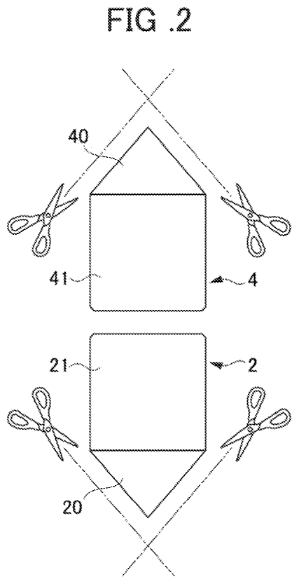

Each of the plurality of positive electrodes 4 includes a positive electrode current collector 40, and a positive electrode layer 41 (see FIG. 2) formed on one surface or both surfaces of the positive electrode current collector 40. The plurality of positive electrodes 4 are laminated with the plurality of negative electrodes 2 and the plurality of solid electrolytes or separators 3 (see FIG. 6) within a predetermined range in which positive electrode layers 41 (see FIG. 2) are formed on surfaces of positive electrode current collectors 40. In the plurality of positive electrodes 4, parts protruding to the other side from the predetermined range in which the positive electrode layers 41 (see FIG. 2) are formed on the surfaces of the positive electrode current collectors 40, i.e., parts where the positive electrode current collectors 40 are exposed, are bonded together with the sealant 6 and bonded to the lead tab 8, whereby a positive electrode current collecting part 4A is formed. The positive electrode current collecting part 4A has a shape that tapers toward a direction away from the predetermined range in which the positive electrode layers 41 (see FIG. 2) are formed on the surfaces of the positive electrode current collectors 40.

The positive electrode current collector 40 is not limited as long as it has a function of collecting electricity of the positive electrode layer 41 (see FIG. 2). Examples of the material of the positive electrode current collector 40 include aluminum, aluminum alloys, stainless steel, nickel, iron, and titanium. Among them, aluminum, aluminum alloys, and stainless steel are preferable.

The positive electrode layer 41 (see FIG. 2) contains at least a positive electrode active material. As the positive electrode active material, a material capable of releasing and occluding a charge transfer medium (e.g., lithium ions) can be selected and used as appropriate. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄) heterogenous element-substituted Li-Mn spinel represented by Li₁+xMn₂-x-yM_{y}O₄ (x+y=2, M is at least one selected from Al, Mg, Co, Fe, Ni, and Zn), and lithium metal phosphate (LiMPO₄, M is at least one selected from Fe, Mn, Co, and Ni).

Specific examples of the sealants 5 and 6 include polyolefin resins (polyethylene and polypropylene). The material of the lead tabs 7 and 8 is not limited, and is preferably a flexible linear plate member such as aluminum (Al) or copper (Cu).

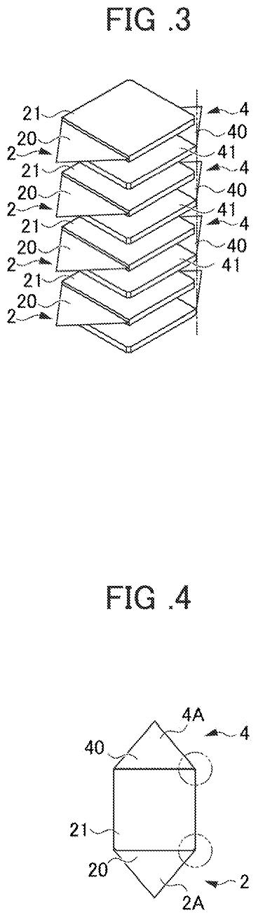

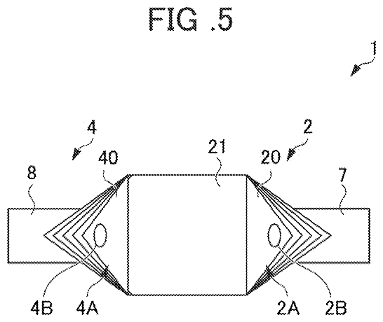

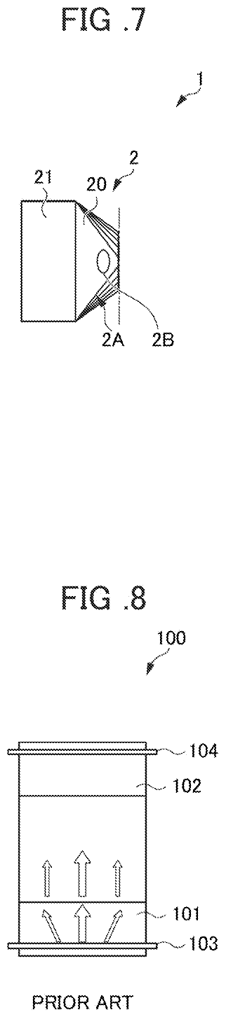

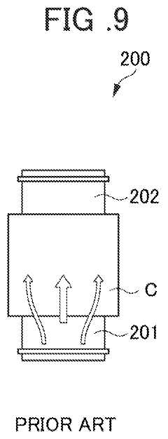

With reference to FIGS. 2 to 7, manufacturing steps of the electrode laminate 1 will be described. FIG. 2 is a plan view explaining a manufacturing step of the electrode laminate 1 and shows a current collector formation step. FIG. 3 is a perspective view explaining a manufacturing step of the electrode laminate 1 and shows a lamination step. FIG. 4 is a plan view explaining a manufacturing step of the electrode laminate 1 and shows lamination misalignment in the lamination step. FIG. 5 is a plan view explaining a manufacturing step of the electrode laminate 1 and shows a bonding step. FIG. 6 is a side view explaining a manufacturing step of the electrode laminate 1 and shows the bonding step. FIG. 7 is a plan view explaining a manufacturing step of the electrode laminate 1 and shows a cutting step.

As shown in FIG. 2, in the current collector formation step, the negative electrode current collector 20 in the negative electrode 2 and the positive electrode current collector 40 in the positive electrode 4 are formed. The negative electrode current collector 20 is formed in a triangular shape that tapers toward a direction away from a predetermined range in which the negative electrode layer 21 is formed on a surface of the negative electrode current collector 20. The positive electrode current collector 40 is formed in a triangular shape that tapers toward a direction away from a predetermined range in which the positive electrode layer 41 is formed on a surface of the positive electrode current collector 40.

The current collector formation step can be performed by linearly cutting the negative electrode current collector 20 and the positive electrode current collector 40 with a cutter, and does not require punching out with a die. This makes the work easy. Further, by linearly cutting, the cutting distance can be shortened, and the risk of contamination due to dust generation can be reduced.

As shown in FIG. 3, in the lamination step, the plurality of negative electrodes 2, the plurality of solid electrolytes 3 (not shown, see FIG. 6), and the plurality of positive electrodes 4 are laminated together within the predetermined range. The plurality of negative electrodes 2 are laminated with the plurality of solid electrolytes 3 (not shown, see FIG. 6) and the plurality of positive electrodes 4 within the predetermined range in which the negative electrode layers 21 are formed on surfaces of the negative electrode current collectors 20. The plurality of positive electrodes 4 are laminated with the plurality of negative electrodes 2 and the plurality of solid electrolytes 3 (not shown, see FIG. 6) within the predetermined range in which the positive electrode layers 41 are formed on the surfaces of the positive electrode current collectors 40.

As shown in FIG. 4, since the negative electrode current collector 20 in the negative electrode 2 and the positive electrode current collector 40 in the positive electrode 4 each are formed in a triangular shape and are angled, it is easy to identify lamination misalignment in the lamination step by checking the parts surrounded by the circles in FIG. 4.

As shown in FIGS. 5 and 6, in the bonding step, bonding parts 2B, in which the negative electrode current collectors 20 are exposed, in the plurality of negative electrodes 2, are bonded together with the sealant 5 (not shown, see FIG. 1) and are bonded to the lead tab 7. Further, in the bonding step, bonding parts 4B, in which the positive electrode current collectors 40 are exposed, in the plurality of positive electrodes 4, are bonded together with the sealant 6 (not shown, see FIG. 1) and are bonded to the lead tab 8.

As shown in FIG. 7, in the cutting step, the tip parts of the negative electrode current collectors 20 beyond the bonding parts are cut, and the tip parts of the positive electrode current collectors 40 (not shown, see FIG. 1) beyond the bonding parts are cut. Since the negative electrode current collector 20 and the positive electrode current collector 40 (not shown, see FIG. 1) each are originally formed in a triangular shape, the cutting distance can be shortened, and the risk of contamination due to dust generation can be reduced.

Thus, the electrode laminate 1 allows the negative electrode current collecting parts 2A and the positive electrode current collecting parts 4A to be smaller. This allows the sealants 5 and 6 to be smaller, resulting in lower manufacturing costs. Further, the electrode laminate 1 allows current C to be dispersed during charging and discharging, thus preventing non-uniform electrode reactions.

Further, when the negative electrode 2 includes lithium metal, the electrode laminate 1 can further prevent non-uniform electrode reactions during charging and discharging.

It should be noted that the present invention is not limited to the above embodiments, and modifications, improvements, and the like are included in the present invention to the extent that the object of the present invention can be achieved. For example, in the present embodiment, the case in which the negative electrode current collecting parts 2A and the positive electrode current collecting parts 4A each have a shape that tapers toward a direction away from a predetermined range has been described as an example, but the present invention is not limited thereto. At least one of the negative electrode current collecting parts 2A or the positive electrode current collecting parts 4A may have a shape that tapers toward a direction away from a predetermined range. In the present embodiment, the electrode laminate 1 has been described as an example, but the present invention is not limited thereto, and may be a secondary battery including the electrode laminate 1.

### EXPLANATION OF REFERENCE NUMERALS

1 electrode laminate
2 negative electrode
2A negative electrode current collecting part
20 negative electrode current collector
21 negative electrode layer
3 solid electrolyte (separator)
4 positive electrode
4A positive electrode current collecting part
40 positive electrode current collector
41 positive electrode layer
5, 6 sealant
7, 8 lead tab
100, 200 electrode laminate
101, 102, 201, 202 tab
103, 104 sealant
C current

What is claimed is:

1. An electrode laminate, comprising:
a plurality of sheet-shaped negative electrodes; a plurality of sheet-shaped solid electrolytes or separators; and a plurality of sheet-shaped positive electrodes,
the plurality of negative electrodes, the plurality of solid electrolytes or separators, and the plurality of positive electrodes being laminated together within a predetermined range,
in the plurality of negative electrodes, negative electrode current collecting parts protruding from the predetermined range to one side being bonded together,
in the plurality of positive electrodes, positive electrode current collecting parts protruding from the predetermined range to the other side being bonded together, and
at least one of the negative electrode current collecting parts or the positive electrode current collecting parts having a shape that tapers toward a direction away from the predetermined range.

2. The electrode laminate according to claim 1, wherein the negative electrodes include at least one of lithium, sodium, potassium, silicon, or alloys thereof.

3. A secondary battery, comprising the electrode laminate according to claim 1.
